(19) United States
(12) Patent Application Publication
(10) Pub. No.: US 2018/0119483 A1
(43) Pub. Date: May 3, 2018

(54) DOOR SWEEP

(71) Applicant: Endura Products, Inc., Colfax, NC (US)

(72) Inventors: Adam Kendall, Greensboro, NC (US); Tom Jaskiewicz, Oak Ridge, NC (US)

(21) Appl. No.: 15/338,032

(22) Filed: Oct. 28, 2016

(51) Int. Cl. E06B 7/22

(52) U.S. Cl. CPC E06B 7/22

(57) ABSTRACT

A door sweep is provided for attachment to a mounting rail of a door assembly with the assistance of an assembly tool to allow for ease of assembly to the door panel while facilitating an effective barrier to external environmental elements.

### FIELD

The present disclosure relates to a door sweep. An aspect of the disclosure provides for a door sweep configured to attach to a mounting rail mounted at the bottom edge of a swinging door panel. The disclosed door sweep offers an improved means for assembly to the mounting rail.

### BACKGROUND

A typical inswing, side-hinged door system utilizes a flexible sealing member, or door sweep, secured to the bottom edge of the door panel. The door sweep interacts with the cap component of the door sill or threshold to create a barrier that can resist infiltration of external elements such as air, water, dirt and debris from the exterior environment into the interior of the building. A door sweep often includes dual, protruding fingers that mate with dual slots in the bottom of the door panel. Flexible fins on the fingers provide a friction fit with the slots to retain the sweep in its desired position on the door panel. Where the door panel does not include slots, other attachments methods may include staples or screws.

Certain door panels used in exterior, side-hinged door assemblies employ a different door sweep design. These door panels have a stamped steel rail with offset edges over which the door sweep slidably engages. The installation involves sliding the door sweep from the proximate end of the rail to the distal end of the rail until the leading edge of the door sweep aligns with the distal end of the rail. This design is disadvantageous because the clearance required for the door sweep to engage the rail reduces the sealing between the door panel and rail and the door. Moreover, the sliding force needed for assembly is often very high, making the process difficult. Accordingly, an advance in the art would be a door sweep that allows for easy assembly to the door panel while facilitating an effective barrier to external environmental elements.

### SUMMARY

The present disclosure provides a door sweep configured to engage a door panel of an exterior, side-hinged door assembly having a stamped steel rail with offset edges. The door sweep is configured with rigid slots that engage with offset edges of the mounting rail. Using an assembly tool, the door sweep may be mounted to the mounting rail.

An embodiment provides a door sweep designed to mate with a door panel mounting rail that allows for easy assembly to the door panel while facilitating an effective barrier to external environmental elements. In this embodiment, opposing, inwardly oriented rigid slots of the door sweep are configured to engage offset edges of a mounting rail. A flexible bulb is co-extruded on the top surface of the sweep to act as a primary seal between the door panel and the door sweep. Co-extruded flexible ribs on the inner faces of the rigid slots mate with the top and bottom surfaces of the offset rail edges to prevent migration of air and water from the exterior to the interior of the building when the door panel is closed, as well as to facilitate retention of the sweep on the rail. Upwardly projecting rigid fingers extend from the base of the door sweep towards the bottom edge of the door panel to maintain a substantially parallel orientation of the base to the bottom of the door panel. The base includes a co-extruded, resilient central segment to allow extension of the base during assembly. The edges of the door sweep include rigid, hooked fingers for receiving a mounting tool.

The resilient sealing members extending from the bottom of the door sweep may embody various configurations that interact with the cap component of the door sill or threshold to create a barrier that can resist infiltration of external elements such as air, water, dirt and debris from the exterior environment into the interior of the building. These elements may be symmetric about the vertical centerline of the door sweep profile to allow for non-oriented attachment.

The mounting of the door sweep to the mounting rail may involve mating one of the rigid slots of the door sweep with one offset edge of the mounting rail substantially along the length of each component. An assembly tool may then be used to grab the hooked finger on the non-engaged edge of the door sweep. Using the face of the door panel as a fulcrum, the tool is rotated towards the top edge of the door panel. This action causes the resilient central segment of the door sweep to extend and allow the second slot of the door sweep to extend past the second offset edge of the mounting rail. As tool rotation continues, the second slot of the door sweep aligns with the second offset edge of the mounting rail. As the tool is released, the resilient central segment of the door sweep contracts and engages the second offset edge of the mounting rail in the second slot of the door sweep. The door sweep is now mounted to the mounting rail.

### BRIEF DESCRIPTION OF THE DRAWINGS

FIG. 1 presents the cross-sectional overview of a door sweep mounted to a stamped steel rail at the bottom edge of the door panel. An assembly tool grabs a hooked finger on one end of the door sweep

FIG. 2 presents the cross sectional view of a door sweep.

FIG. 3 presents the cross sectional view of the door sweep and sill interaction.

### DETAILED DESCRIPTION

All patents and other publications identified (including U.S. patent application Ser. No. 14/717,194 and U.S. design patent application Ser. No. 29/527,556) are incorporated herein by reference for the purpose of describing and disclosing, for example, the methodologies described in such publications that might be used in connection with the present invention, but are not to provide definitions of terms inconsistent with those presented herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on information available to the applicants and do not constitute any admission as to the correctness of the dates or contents of these documents.

As used herein and in the claims, the singular forms “a,” “an,” and “the” include the plural reference unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either.” Other than in the operating examples, or where otherwise indicated, all numbers expressing quantities of ingredients or reaction conditions used herein should be understood as modified in all instances by the term “about.”

Unless defined otherwise, all technical and scientific terms used herein have the same meaning as those commonly understood to one of ordinary skill in the art. The terminology used herein is for the purpose of describing particular embodiments only, and is not intended to limit the scope of the present invention, which is defined solely by the claims. The terms male and female may be used interchangeably to describe corresponding components or complementary aspects thereof and are not a limitation to either particular structure unless context clearly indicates otherwise.

Headings are provided for convenience only and are not to be construed to limit the invention in any way. Unless defined otherwise, all technical and scientific terms used herein have the same meaning as those commonly understood to one of ordinary skill in the art. The terminology used herein is for the purpose of describing particular embodiments only, and is not intended to limit the scope of the present invention, which is defined solely by the claims. In order that the present disclosure can be more readily understood, certain terms are first defined. Additional definitions are set forth throughout the detailed description.

An embodiment of the disclosed door sweep comprises a base with an extruded resilient segment at the center of the base for easy extension while the door sweep is being installed to a door mounting rail by a mounting tool. There may be at least one rigid rail mounting slot on the top edge of the base for receiving an offset edge of the mounting rail. There may be at least one rigid hooked finger on the outer edge of the base for receiving the mounting tool. At least one rigid finger may be projecting upwardly from the top of the base for keeping the base relatively parallel to the bottom edge of the door panel. A resilient sealing member may be extending downwardly from the bottom of the base for sealing the interface between the door sweep and a door sill assembly.

The rigid rail mounting slot may optionally have at least one flexible rib on an inside face of the slot for sealing with and retention on an offset edge of the rail. Alternatively, the rigid rail mounting slot may have two flexible ribs, one on the top and the second on the bottom of the inside face of the slot for better sealing with and retention on an offset edge of the mounting rail. The rigid hooked finger may optionally have at least one flexible bulb on top of the finger for sealing with the bottom edge of the door panel. The resilient sealing members extending from the bottom of the door sweep may embody various configurations that interact with the cap component of the door sill or threshold to create a barrier that can resist infiltration of external elements such as air, water, dirt and debris from the exterior environment into the interior of the building. These configurations may embody various size, shape and quantities. The door sweep may be symmetric about the vertical centerline of the door sweep profile and allow for non-oriented attachment.

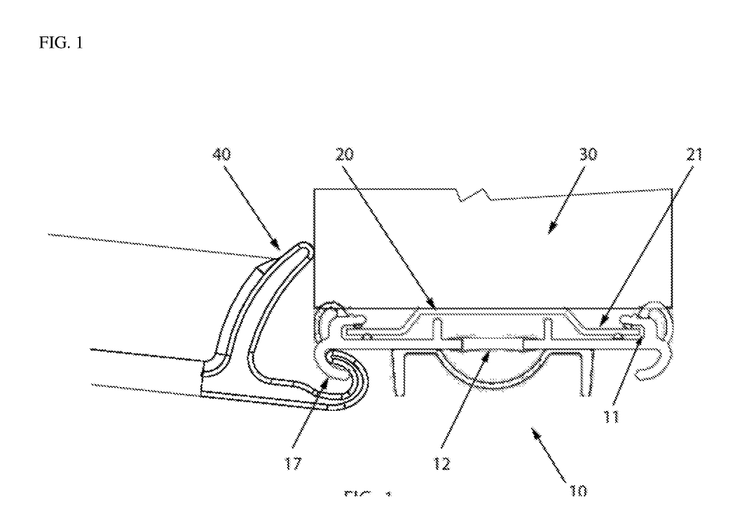

FIG. 1 shows an embodiment of a door sweep 10 constructed and arranged to be attached to a door stamped steel rail 20 mounted at the bottom of the door panel 30 with the assistance of an assembly tool 40. The assembly is provided by first mating one of the sweep's rigid slots 11 with one offset edge 21 of the rail, this along the length of each component. The first edge of an assembly tool 40 is placed into the hooked finger 17 on the non-engaged edge of the sweep 10. Using the face of the door panel 30 as a fulcrum, the second edge of the tool 40 is placed onto the surface of the door panel 30. The tool 40 is rotated towards the top edge of the door panel 30. This action causes the resilient central segment 12 of the sweep to extend, allowing the second slot of the sweep to extend past the second, offset rail edge. As tool rotation continues the second sweep slot aligns with the second rail edge. Upon release of the tool 40, the sweep central segment 12 contracts and engages the second rail edge in the second slot. The sweep 10 is now mated to the rail 20.

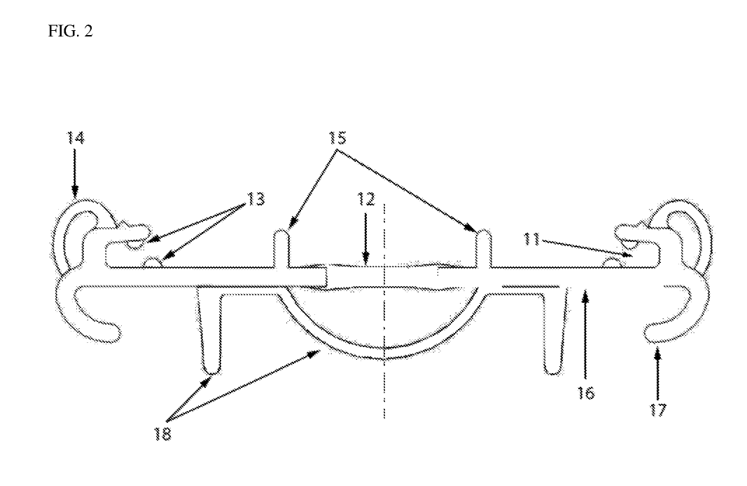

FIG. 2 shows an embodiment of a door sweep including two opposing inwardly oriented rigid slots 11 which receive offset edges 21 of a mounting rail 20. Co-extruded flexible ribs 13 on the inner faces of the rigid slots 11 mate with the top and bottom surfaces of the offset rail edges 21 to prevent migration of air or water from the exterior to the interior of a building when the door panel is closed. A flexible bulb 14 is co-extruded on the top surface of the sweep 10 to act as a primary seal between the door panel 30 and sweep 10. Upwardly projecting rigid fingers 15 extend from the sweep's base 16 towards the door panel's bottom edge. These fingers act as spacers to keep the base relatively parallel to the bottom edge of the door panel 30. The base 16 includes a co-extruded resilient, central segment 12. The edges of the sweep include rigid, inward-protruding, hooked fingers 17 for receiving a mounting tool. At least one resilient sealing member 18 is extending form the bottom of the sweep base 16. The sealing member mates with the door sill/threshold cap component to ensure a weather seal at this intersection. The features described above are symmetric about the vertical centerline of the sweep profile and allow for non-oriented attachment.

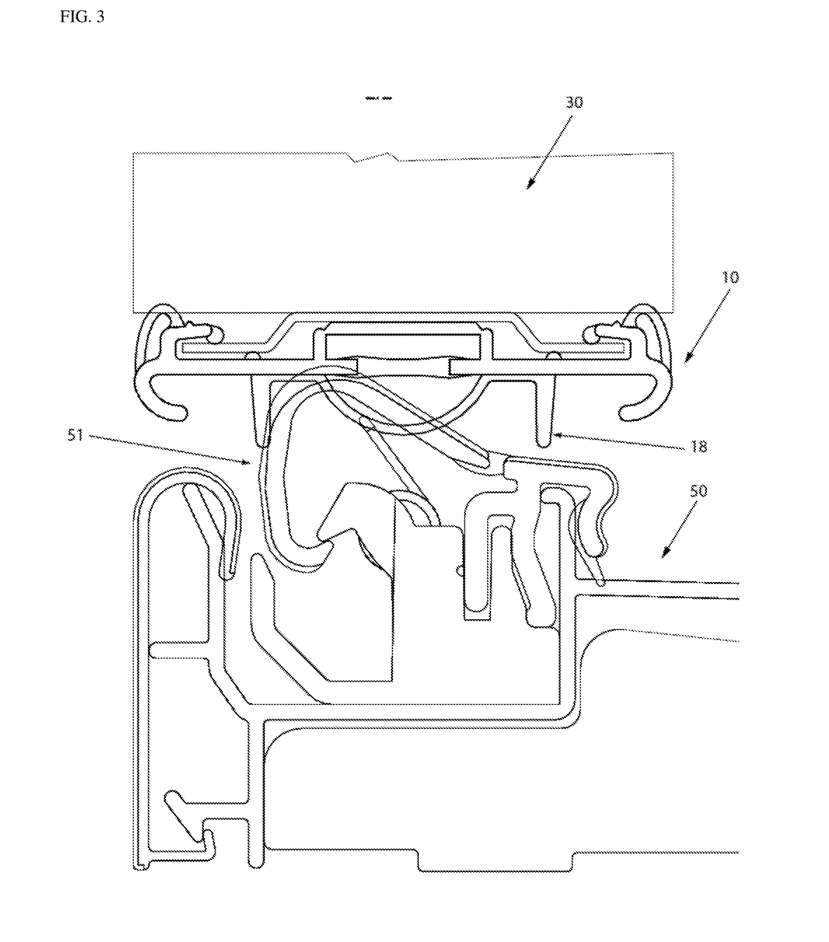

FIG. 3 shows an embodiment of a door sweep 10 which is constructed and arrange to enable a sealing relation with the sill assembly 50 mounted on the floor and the door mounting rail 20 when the door panel 30 is in closed position. When the door is closed, the resilient sealing member 18 of the door sweep is closely engaging with a sill cap 51 of the sill assembly mounted on the floor to ensure a weather seal between the floor and the door sweep.

It should be understood that the examples and embodiments described herein are for illustrative purposes only and that various modifications or changes in light thereof will be suggested to persons skilled in the art and are to be included within the spirit and purview of this application and the scope of the appended claims. All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

We claim:

1. A door sweep comprising
a base wherein the base comprises
a resilient segment;
at least one rigid rail mounting slot on the top edge of the base configured to engage an edge of mounting rail mounted at the bottom of a door panel; and
at least one rigid hooked finger on the outer edge of the base configured to engage a mounting tool.

2. The door sweep of claim 1 wherein the base further comprises at least one rigid finger projecting upwardly from the top of the base.

3. The door sweep of claim 1 wherein the base further comprises a resilient sealing member extending downwardly from the bottom of the base.

4. The door sweep of claim 1 wherein the rigid hooked finger further comprises at least one flexible bulb on top of the finger for sealing with the bottom edge of the mounting rail.

5. A method for attaching a door sweep to a door panel comprising
positioning a first rigid rail mounting slot over a first edge of a mounting rail attached to a door panel;
engaging a first edge of a mounting tool into a rigid hooked finger of a door sweep;
engaging a second edge of the mounting tool onto the face of the door panel;
rotating the mounting tool towards the top edge of the door panel;
extending a second rigid rail mounting slot away from the first rigid rail mounting slot whereby the second rigid rail mounting slot aligns with a second edge of the mounting rail attached to the door panel;
disengaging the mounting tool from the rigid hooked finger of a door sweep while maintaining the position of the second edge of the door sweep.

6. The method of claim 5 wherein the recited steps in sequence are repeated along the length of the door sweep until the door sweep completely engages the mounting rail.
